(19) United States
(12) Patent Application Publication
(10) Pub. No.: US 2026/0285054 A1
(43) Pub. Date: Sep. 24, 2026

(54) INKJET RECORDING APPARATUS

(71) Applicant: KYOCERA Document Solutions Inc., Osaka (JP)

(72) Inventors: Yoshihiro YAMAGISHI, Osaka-shi, Osaka (JP); Hideki ISHIDA, Osaka-shi, Osaka (JP); Hiroaki WATANABE, Osaka-shi, Osaka (JP); Takeru YOSHIDA, Osaka-shi, Osaka (JP)

(73) Assignee: KYOCERA Document Solutions Inc., Osaka (JP)

(21) Appl. No.: 19/470,018

(22) PCT Filed: May 16, 2024
(86) PCT No.: PCT/JP2024/018069

§ 371 Date: Sep. 26, 2025

(30) Foreign Application Priority Data
Mar. 29, 2023 (JP) 2023-053966

(51) Int. Cl. B41J 2/19; B41J 2/045; B41J 2/165; B41J 2/175

(52) U.S. Cl. CPC B41J 2/19; B41J 2/0451; B41J 2/04573; B41J 2/04586; B41J 2/16505; B41J 2/17596; B41J 2202/07; B41J 2202/12

(57) ABSTRACT

An inkjet recording apparatus (1) includes a recording head (21) which ejects a liquid; a bubble countermeasure means for executing a bubble countermeasure treatment determined as a countermeasure against bubbles generated in the liquid; a bubble generation amount calculation means for calculating an amount of bubbles generated from the liquid; and a control device (38) which relaxes the bubble countermeasure treatment when the amount of bubble generation calculated by the bubble generation amount calculation means is equal to or less than a predetermined amount.

### TECHNICAL FIELD

The present invention relates to an inkjet recording apparatus.

### BACKGROUND

In an inkjet recording apparatus, when an amount of dissolved air of ink increases, bubbles may be generated inside a recording head, resulting in ejection failure. Therefore, a technique for reducing the amount of dissolved air in the ink has been studied. As an example, there is known a configuration in which the ink is degassed by reducing pressure in the ink tank. For example, Patent Document 1 discloses a configuration in which a stirrer provided in the ink tank is rotated by a magnetic force applied from the outside to stir the ink.

### PRIOR ART DOCUMENTS

### Patent Document

Patent Document 1: Japanese Patent Laid-Open No. 2010-162821

### SUMMARY OF THE INVENTION

### Problems to be solved by invention

Since an amount of saturated dissolved gas in the ink depends on a temperature of the ink, an amount of bubbles generated from the ink is determined by the temperature change of the ink. For example, the larger the temperature increase range of the ink, the larger the decrease in the amount of saturated dissolved gas, and therefore, the amount of bubble generation increases. Therefore, in order to maintain the ejection performance of the recording head, it is important to take countermeasures according to the amount of bubble generation.

It is an object of the present invention to provide an inkjet 1 apparatus capable of performing countermeasures against bubbles depending on the amount of bubble generation.

### Means of Solving the Problems

An inkjet recording device according to the present invention includes a recording head which ejects a liquid; a bubble countermeasure means for executing a bubble countermeasure treatment determined as a countermeasure against bubbles generated in the liquid; a bubble generation amount calculation means for calculating an amount of bubbles generated from the liquid; and a control device which relaxes the bubble countermeasure treatment when the amount of bubble generation calculated by the bubble generation amount calculation means is equal to or less than a predetermined amount.

### Effects of the Invention

According to the present invention, it becomes possible to perform countermeasures against bubbles depending on the amount of bubble generation.

### BRIEF DESCRIPTION OF DRAWING

FIG. 1 is a schematic view showing an inkjet recording apparatus according to one embodiment of the present invention.

FIG. 2 is a schematic view showing an ink supply structure according to the embodiment of the present invention.

FIG. 3 is a schematic view showing a circulation pump according to the embodiment of the present invention.

FIG. 4 is a flow diagram showing a whole of a bubble countermeasure treatment according to the embodiment of the present invention.

FIG. 5 is a flow diagram showing a process for calculating an amount of bubble generation according to the embodiment of the present invention.

### EMBODIMENT FOR CARRYING OUT THE INVENTION

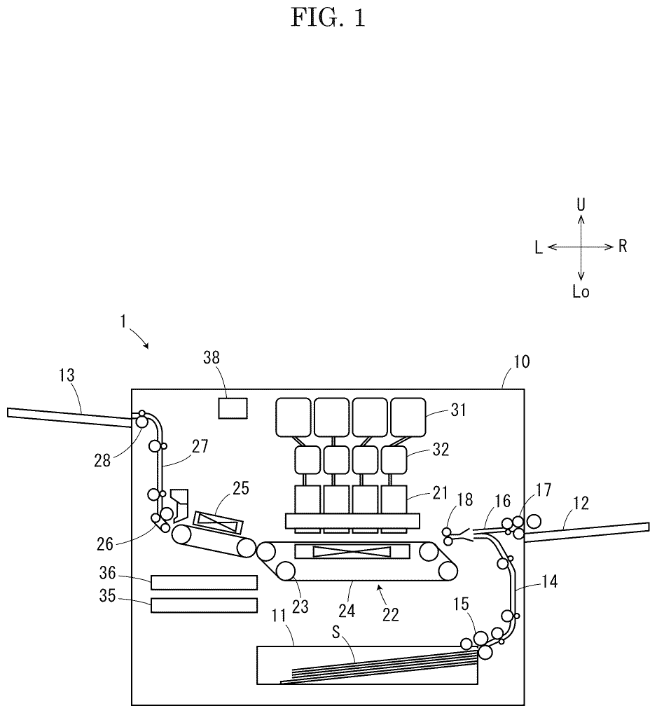

Hereinafter, with reference to the drawings, an inkjet recording apparatus 1 the present embodiment will be described. FIG. 1 is a schematic view showing the inkjet recording apparatus 1. For convenience of explanation, the front side of the paper surface on which FIG. 1 is drawn is defined as the front side of the inkjet recording apparatus 1, and the left-and-right direction will be described with reference to the direction in which the inkjet recording apparatus 1 is viewed from the front side. The arrows L, R, U, and Lo attached to each figure indicate the left, right, upper, and lower sides of the inkjet recording apparatus 1, respectively.

As shown in FIG. 1, the inkjet recording apparatus 1 is formed so as to perform printing by ejecting ink (an example of the liquid) from each inkjet recording head 21 toward a sheet S as a recording medium. The inkjet recording apparatus 1 includes a box-shaped housing 10 in which various devices are housed. A sheet feeding cassette 11 in which the sheet S is set is housed in the lower portion of the housing 10, and a manual sheet feeding tray 12 on which the sheet S is set by hand is installed on the right side surface of the housing 10. On the upper portion of the left side surface of the housing 10, a sheet discharge tray 13 on which the recorded sheet S is loaded is installed.

In the right side portion in the housing 10, a first conveyance path 14 along which the sheet S is conveyed from the sheet feeding cassette 11 to the recording head 21 provided in the center of the housing 10 is formed. On the upstream side of the first conveyance path 14, a first sheet feeding part 15 which feeds the sheet S from the sheet bundle in the sheet feeding cassette 11 is provided, and a pair of registration rollers 18 which adjusts a feeding timing of the sheet S is provided in the downstream portion of the first conveyance path 14. Further, a sheet feeding path 16 extending from the manual sheet feeding tray 12 is merged with the downstream portion of the first conveyance path 14, and a second sheet feeding part 17 which feeds the sheet S from the sheet bundle on the manual sheet feeding tray 12 is provided on the sheet feeding path 16.

On the downstream side of the pair of registration rollers 18, a conveying device 22 and the recording head 21 provided for each color (for example, black, cyan, magenta, and yellow) are installed. The pair of registration rollers 18 corrects the skew of the sheet S, and then sends the sheet S to the conveying device 22 in accordance with an ink ejecting operation by each recording head 21. In the housing 10, an ink container 31 and an ink tank 32 are provided for each recording head 21. The ink of each ink container 31 is temporarily stored in the ink tank 32, the ink is degassed as necessary, and then the ink is supplied from the ink tank 32 to the recording head 21.

The conveying device 22 is constituted by winding a conveyance belt 24 around a plurality of tension rollers 23 installed below the recording heads 21. On the downstream side of the conveying device 22, a drying device 25 which dries the ink of the sheet S is provided. On the downstream side of the drying device 25, a decurl device 26 which corrects a curl generated on the sheet S by drying the ink is provided. On the downstream side of the decurl device 26, a second conveyance path 27 along which the sheet S is conveyed toward the sheet discharge tray 13 is formed. In the downstream portion of the second conveyance path 27, a sheet discharge part 28 which discharges the recorded sheet S to the sheet discharge tray 13 is provided.

Below the drying device 25, a maintenance unit 35 which cleans the recording heads 21 and a cap unit 36 which caps the recording heads 21 are provided. The maintenance unit 35 is provided with a squeegee-shaped wiping blade, and the wiping blade scrapes the ink remaining on the nozzle surface of the recording head 21. The cap unit 36 is provided with a head cap, and the nozzle surface of the recording head 21 is capped with the head cap. The head cap suppresses drying of the ink in the nozzle. The drying of the ink in the nozzle may be further suppressed by storing a liquid such as a cleaning liquid in the head cap.

Further, the inkjet recording apparatus 1 is provided with a control device 38 for controlling the entire apparatus. The control device 38 may be constituted by a processor or a logic circuit (hardware) formed in an integrated circuit or the like. In the case of a processor, the processor reads and executes a program stored in a memory, and various processes are executed. For example, a CPU (Central Processing Unit) is used as the processor. The memory is constituted by one or more storage devices such as a ROM (Read Only Memory), a RAM (Random Access Memory) or the like depending on the application.

At the time of image recording (printing), the sheet S is fed from the sheet feeding cassette 11 or the manual sheet feeding tray 12 by the first sheet feeding part 15 or the second sheet feeding part 17, respectively, and then sent to the pair of registration rollers 18. In accordance with the ejecting timing of the ink, the sheet S is conveyed from the pair of registration rollers 18 to the conveyance belt 24, the degassed ink is ejected from each recording head 21, and a color image is recorded on the surface of the sheet S. The sheet S is dried by the drying device 25, and the curl of the sheet S is corrected by the decurl device 26. The sheet S is conveyed to the sheet discharge part 28 through the second conveyance path 27, and the recorded (printed) sheet S is discharged to the sheet discharge tray 13 by the sheet discharge part 28.

By the way, the liquid surface of the ink comes into contact with air in the ink tank 32, and the dissolving of the air proceeds, and the nozzle of the recording head 21 may be clogged by bubbles in the ink. Therefore, it is desired to appropriately keep an amount of dissolved gas in the ink. For example, a method has been proposed in which by passing the ink through the hollow fiber filter in a state where the pressure of the circumference of the hollow fiber filter is reduced, the air is moved from the wall surface of the hollow fiber to the pressure decreased side to degas the ink. This method requires the expensive hollow fiber filter and requires periodic replacement operations, which increase cost.

In order to prevent the clogging of the nozzle, a system (hereinafter referred to as a stirring degassing system) has been proposed in which the ink is stirred by a stirrer in a state in which the pressure in the ink tank 32 is reduced below an atmospheric pressure to degas the ink. In the stirring degassing system, a magnetic force is applied to the stirrer in the ink tank 32 from the outside, and the stirrer is rotated by the magnetic force to stir the ink in the ink tank 32. When the depth of the ink and the tank diameter are large, the ink is difficult to be stirred, and the degassing efficiency is lowered. as the rotational speed of the stirrer is increased, the ink is easily stirred, but when the rotational speed of the stirrer becomes too high, a loss of synchronization occurs and the rotational sound of the stirrer becomes large.

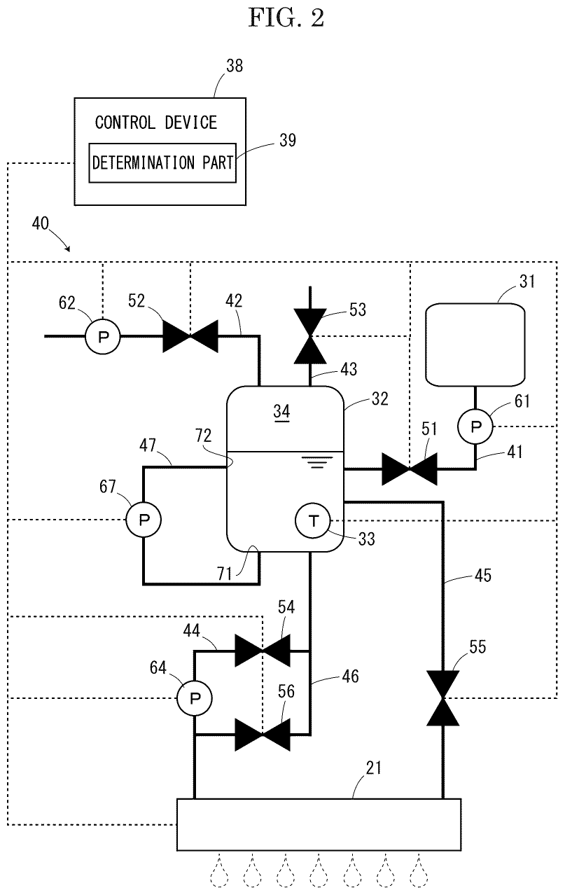

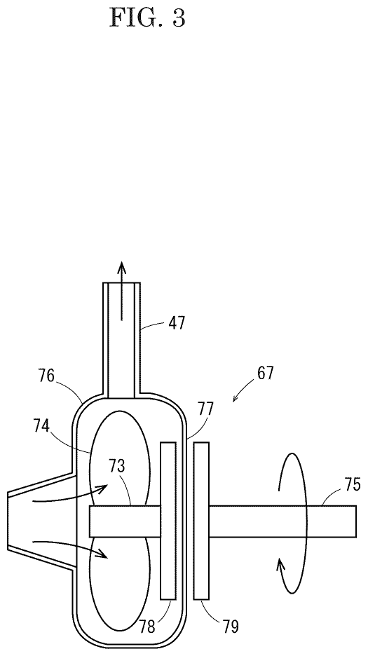

Therefore, in the present embodiment, a system (hereinafter referred to as a circulation degassing system) is adopted in which the ink in the ink tank 32 is circulated through a circulation flow path 47 and degassed while the pressure in the ink tank 32 is reduced to an atmospheric pressure or lower (see FIG. 2). In the circulation degassing system, since the ink circulates in the circulation flow path 47 and the ink tank 32, the ink near the liquid surface where an amount of dissolved air is small is replaced with the ink near the bottom surface where an amount of dissolved air is large, thereby improving the degassing efficiency. Unlike the stirring degassing system, it is not affected by the depth of the ink or the tank diameter, and the driving sound of the circulation pump 67 is suppressed rather than the rotational sound of the stirrer, thereby improving the quietness.

[Degassing Device] The degassing device 40 according to the present embodiment will be described. FIG. 2 is a schematic view showing an ink supply structure. FIG. 3 is a schematic view showing a circulation pump 67 according to the present embodiment. Although the inkjet recording apparatus 1 according to the present embodiment is provided with the ink supply structure for each color, one ink supply structure will be described here.

[Replenishment Flow Path] As shown in FIG. 2, the ink tank 32 stores the ink supplied from the ink container 31 through a replenishment flow path 41. In the replenishment flow path 41, a replenishment pump 61 and a replenishment valve 51 are provided, and the replenishment of the ink to the ink tank 32 is controlled by the replenishment pump 61 and the replenishment valve 51.

[Reduced Pressure Flow Path] The upper space 34 of the ink tank 32 is communicated with a pressure reducing flow path 42. In the pressure reducing flow path 42, a pressure reducing pump 62 is provided.

[Atmosphere Opening Flow Path] The upper space 34 of the ink tank 32 is communicated with an atmosphere opening flow path 43. The atmosphere opening flow path 43 is provided with an atmosphere opening valve 53, and the upper space 34 is opened to the atmosphere by the atmosphere opening valve 53.

[Supply Flow Path, Recovery Flow Path, Bypass Flow Path, Head Circulation Means] The ink is supplied from the ink tank 32 to the recording head 21 through a supply flow path 44, and recovered from the recording head 21 to the ink tank 32 through a recovery flow path 45. The supply flow path 44 is provided with a supply pump 64 and a supply valve 54, and the recovery flow path 45 is provided with a recovery valve 55. An ink replacement operation and a bubble removal operation in the recording head 21 are controlled by the supply pump 64, the supply valve 54 and the recovery valve 55. These forms a head circulation means for circulating the ink between the ink tank 32 and the recording head 21. A bypass flow path 46 bypassing the supply pump 64 is communicated with the supply flow path 44, and a bypass valve 56 is provided in the bypass flow path 46. In the printing, the ink is passed through the bypass flow path 46 by the bypass valve 56. That is, in the printing, the head circulation is not performed.

[Circulation Flow Path] The vicinity of the liquid surface of the ink and the vicinity of the bottom surface of the ink tank 32 communicate with each other through the circulation flow path 47. The circulation flow path 47 is provided with a circulation pump 67, and the ink is circulated through the circulation flow path 47 by the circulation pump 67. An inflow port 72 from the circulation flow path 47 to the ink tank 32 is higher than an outflow port 71 from the ink tank 32 to the circulation flow path 47. Specifically, the outflow port 71 is opened on the bottom surface of the ink tank 32, and the inflow port 72 is opened on the side surface of the ink tank 32 near the liquid surface.

[Circulation Pump] Since the inside of the ink tank 32 is in the reduced pressure state during the degassing operation, a reciprocating pump such as a diaphragm pump is easily affected by the reduced pressure. Therefore, it is preferable that the circulation pump 67 is a pump for feeding the ink by a rotating body. For example, as the circulation pump 67, a non-positive displacement pump such as a centrifugal pump, a diagonal flow pump, an axial flow pump, or a positive displacement rotary pump such as a vane pump, a gear pump, a screw pump, or the like may be used. By using these pumps, unlike the reciprocating pump, the ink can be circulated while suppressing the influence of pressure reduction in the ink tank 32.

In general, the recording head 21 may be included in the middle of the degassing circulation flow path 47 in the circulation degassing system, but in this embodiment, the recording head 21 is not included in the circulation flow path 47. That is, the circulation flow path 47 is provided separately from the flow path for supplying the ink to the recording head 21. Since the recording head 21 is not included in the circulation flow path 47, the possibility that the meniscus formed in the nozzle of the recording head 21 is destroyed by the pressure reducing at the time of degassing and the outside air enters the recording head 21 can be reduced.

As shown in FIG. 3, a power can be transmitted between a pump shaft 73 of the circulation pump 67 and a motor shaft 75 across a partition wall 77 in a non-contact manner. A pump casing 76 is formed in the middle of the circulation flow path 47, and the pump shaft 73 with an impeller 74 is housed in the pump casing 76. A motor (not shown) is provided outside the circulation flow path 47. Disks 78 and 79 are provided at the ends of the pump shaft 73 and the motor shaft 75, and the disks 78 and 79 face each other across the partition wall 77 of the pump casing 76. Magnets (not shown) having S poles and N poles alternately arranged in the circumferential direction are disposed on the opposing surfaces of the disks 78 and 79.

The pump shaft 73 and the motor shaft 75 are magnetically coupled (magnet coupling), and the power is transmitted from the motor shaft 75 to the pump shaft 73 using a magnetic force. The impeller 74 in the pump casing 76 can be rotated while the pump casing 76 is liquid-tightly sealed without penetrating the motor shaft 75 through the pump casing 76. Since the space between the disk 78 of the pump shaft 73 and the disk 79 of the motor shaft 75 is partitioned by the partition wall 77 of the pump casing 76, even if a pressure difference occurs between the inside and the outside of the pump casing 76 when the pressure in the ink tank 32 is reduced, ink leakage caused by the pressure difference is surely prevented.

[Control Device] The replenishment pump 61, the pressure reducing pump 62, the supply pump 64, the circulation pump 67, the replenishment valve 51, the pressure reducing valve 52, the atmosphere opening valve 53, the supply valve 54, the recovery valve 55, and the bypass valve 56 are controlled by the control device 38. The control device 38 is provided with a determination part 39 which determines whether the degassing operation is necessary in accordance with an ink standing time. When the determination part 39 determines that the degassing of the ink is unnecessary, the degassing operation is regulated. Even if the air is re-dissolved by leaving the ink, the ink can be used without the degassing within an allowable time. The details of the determination process executed by the determination part 39 will be described later. In the ink supply structure of the inkjet recording apparatus 1, the degassing device 40 is formed by the ink tank 32, the pressure reducing flow path 42, the pressure reducing pump 62, the pressure reducing valve 52, the circulation flow path 47, the circulation pump 67, the determination part 39, and the others.

Next, an operation of the degassing device 40 (an example of the degassing means) will be described. In the standby state of the inkjet recording apparatus 1, the replenishment valve 51, the pressure reducing valve 52, and the supply valve 54 are closed, and the atmosphere opening valve 53, the bypass valve 56, and the recovery valve 55 are opened. The ink is stored in the ink tank 32, and when the liquid surface comes into contact with the air in the upper space 34 opened to the atmosphere, the air is dissolved in the ink with the passage of time. In the pressure reducing operation, only the pressure reducing valve 52 is opened, and the other valves 51, 53 to 56 are closed. The pressure reducing pump 62 is driven to draw air from the upper space 34 in the ink tank 32. When the pressure inside the ink tank 32 reaches the target pressure (for example, −50 [kPa] ), the pressure reducing pump 62 is stopped.

In the degassing operation, all the valves 51 to 56 are closed, and the circulation pump 67 is driven while the pressure reduced state in the ink tank 32 is maintained, and the ink in the ink tank 32 is circulated through the circulation flow path 47. The ink near the bottom surface of the ink tank 32 where an amount of dissolved air is large flows out to the circulation flow path 47 through the outflow port 71, and the ink in the circulation flow path 47 flows into the vicinity of the liquid surface in the ink tank 32 through the inflow port 72. The liquid surface of the ink is exposed to the reduced pressure atmosphere to remove the air dissolved in the ink near the liquid surface. The ink near the liquid surface where an amount of dissolved air is small is smoothly replaced with the ink near the bottom surface where an amount of dissolved air is large, and the degassing efficiency is improved.

As shown in FIG. 2, when the head circulation means is operated, the replenishment valve 51, the pressure reducing valve 52, and the bypass valve 56 are closed, and the atmosphere opening valve 53, the supply valve 54, and the recovery valve 55 are opened. The supply pump 64 is driven to supply the ink from the ink tank 32 to the recording head 21 through the supply flow path 44, and the ink is recovered from the recording head 21 to the ink tank 32 through the recovery flow path 45. By circulating the ink between the recording head 21 and the ink tank 32, the ink having an increased viscosity in the recording head 21 is replaced and bubbles are removed from the recording head 21.

At the time of printing operation by the recording head 21, the replenishment valve 51, the pressure reducing valve 52, and the supply valve 54 are closed, and the atmosphere opening valve 53, the bypass valve 56 and the recovery valve 55 are opened. That is, during the printing operation, the ink tank 32 is opened into the atmosphere, and is at atmospheric pressure. During the printing operation, the ink tank 32 is not reduced in pressure to the extent that substantial degassing occurs. Every time the ink is ejected from the recording head 21, the ink is supplied from the ink tank 32 to the recording head 21 through the bypass flow path 46 and the recovery flow path 45. The ink may be replenished in the middle of the ink replacement operation and the printing operation. At the ink replenishment operation, the replenishment valve 51 is opened, and the replenishment pump 61 is driven. By the driving the replenishment pump 61, the ink is replenished from the ink container 31 to the ink tank 32 through the replenishment flow path 41.

FIG. 1 and the others are schematically drawn, and the recording head 21 is actually disposed above the ink tank 32. A negative pressure is applied to the ink in the recording head 21 by a head difference from the ink in the ink tank 32, and a meniscus is formed in the nozzle of the recording head 21 by the negative pressure. After the ink is ejected from the recording head 21, the surface tension of the ink acts to reduce the surface area of the meniscus, and the resulting negative pressure draws the reduced amount of the ink from the ink tank 32 into the recording head 21. The recovery valve 55 may be closed to supply the ink to the recording head 21 only from the bypass flow path 46.

If the pressure in the ink tank 32 is reduced to the extent that substantial degassing occurs in a state where the recording head 21 and the ink tank 32 are connected, the meniscus of the nozzle may be destroyed. Even if the meniscus is not destroyed, there is a risk that the shape of the meniscus in the nozzle is changed compared with the case where the ink tank 32 is released to the atmosphere, and the ejecting characteristic of the ink is changed. In the present embodiment, since the pressure in the ink tank 32 is not reduced so as not to cause substantial degassing during the printing operation, the meniscus in the nozzle of the recording head 21 is not destroyed, and since its shape is not changed, the ejection characteristic is not changed.

Next, a bubble countermeasure treatment will be described. The inkjet recording apparatus 1 according to the present embodiment includes the recording head 21 which ejects the liquid, the bubble countermeasure means for executing a bubble countermeasure treatment determined as a countermeasure against bubbles in the liquid, a bubble generation amount calculation means for calculating an amount of bubbles generated from the liquid, and a control means for relaxing the bubble countermeasure treatment when an amount of bubble generation calculated by the bubble generation amount calculation means is equal to or less than a predetermined amount. Details are provided below.

The bubble countermeasure treatment is a treatment determined as a countermeasure against bubbles in the ink. The bubble countermeasure treatment includes a non-ejection detection means, a purge means, the head circulation means and a degassing means. The non-ejection detection means ejects the ink from the recording head 21 to the sheet S according to the image data prepared in advance, and optically reads the image formed on the sheet S to detect a nozzle from which the ink is not ejected. The purge means forcibly ejects the ink from the nozzle to the cap unit 36 by the supply pump 64.

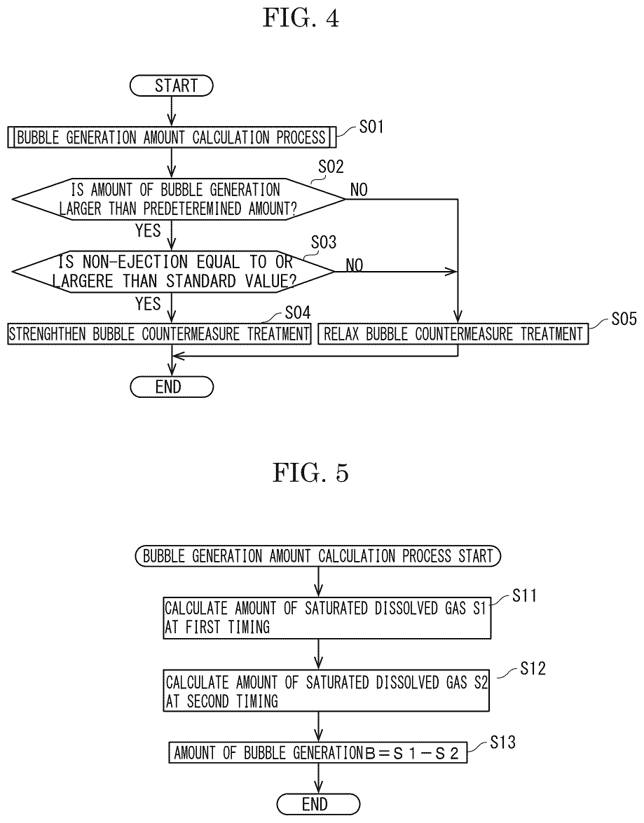

FIG. 4 is a flow diagram showing the entire of the bubble countermeasure treatment. The control device 38 (an example of the control means) executes the bubble countermeasure treatment when the power to the inkjet recording apparatus 1 is turned on and periodically after the power is turned on. First, the control device 38 executes the calculation means of an amount of bubble generation (step S01).

FIG. 5 is a flowchart showing the calculation means of an amount of bubble generation. First, the control device 38 calculates an amount of saturated dissolved gas S1 at the first timing (step 11). Specifically, a temperature sensor 33 is provided below the liquid surface inside the ink tank 32. The first timing is, for example, a timing of the last degassing operation, and the temperature of the ink in the ink tank 32 at that timing is stored in the determination part 39. The determination part 39 stores conversion information indicating a correspondence between an ink temperature and an amount of saturated dissolved gas, and the amount of saturated dissolved gas is estimated based on the temperature measured by the temperature sensor 33. As the conversion information, map data, a lookup table, a conversion formula, and the like are used. These map data, lookup tables, and conversion formulas are obtained experimentally, empirically, and theoretically in advance.

Next, the control device 38 calculates an amount of saturated dissolved gas S2 at the second timing (step 12). The second timing is, for example, the timing at which step S12 is being executed, that is, the current time. The control device 38 estimates the amount of saturated dissolved gas based on the temperature measured by the temperature sensor 33.

Next, the control device 38 calculates an amount of bubble generation B. The amount of bubble generation B is a value obtained by subtracting the amount of saturated dissolved gas S2 at the second timing from amount of saturated dissolved gas S1 at the first timing.

Next, the control device 38 determines whether the amount of bubble generation is larger than a predetermined amount (FIG. 4, step S02). The predetermined amount is, for example, 0 (zero). If it is determined that the amount of bubble generation is larger than the predetermined amount, that is, that the amount of bubble generation is a positive value (step S02: YES), the control device 38 determines whether the non-ejection detected by the non-ejection detection means is equal to or larger than the reference value (step S03). If it is determined that the non-ejection is equal to or larger than the reference value (step S03: YES), the control device 38 strengthens the bubble countermeasure treatment (step S04). On the other hand, when it is determined that the amount of bubble generation is equal to or less than the predetermined amount, that is, that the amount of bubble generation is 0 (step S02: NO), or that the non-ejection is less than the reference value (step S03: NO), the control device 38 relaxes the bubble countermeasure treatment (step S05).

A specific example of strengthening the bubble countermeasure treatment in step S04 will now be described. For example, the control means may increase the amount of ejection or the ejection frequency of the purge means to strengthen the bubble countermeasure treatment (a first embodiment). Alternatively, the control means may increase the circulation time or the circulation frequency of the head circulation means to strengthen the bubble countermeasure treatment (a second embodiment). That is, when the supply pump 64 for generating the head circulation is operated, the operation time per operation is increased or the operation frequency is increased. An increase in the operation time may increase the operating time per unit time. Alternatively, the control means may increase the degassing time or the degassing frequency of the degassing means to strengthen the bubble countermeasure treatment (a third embodiment). The control means may execute two or more of the first to third embodiments to strengthen the bubble countermeasure treatment.

Next, a specific example of the relaxation of the bubble countermeasure treatment in step S05 will be described. For example, the control means may decrease the amount of ejection or the ejection frequency of the purge means to relax the bubble countermeasure treatment (a fourth embodiment). Alternatively, the control means may decrease the circulation time or the circulation frequency of the head circulation means to relax the bubble countermeasure treatment (a fifth embodiment). That is, when the supply pump 64 for generating the head circulation is operated, the operation time per operation is decreased or the operation frequency is decreased. The decrease in the operating time may decrease the operating time per unit time. Alternatively, the control means may decrease the degassing time or the degassing frequency of the degassing means to relax the bubble countermeasure treatment (a sixth embodiment). The control means may execute two or more of the fourth to sixth embodiments to relax the bubble countermeasure treatment.

The inkjet recording apparatus 1 according to the present embodiment described above includes the recording head 21 which ejects the liquid, the bubble countermeasure means for executing the bubble countermeasure treatment determined as the countermeasure against bubbles in the liquid, the bubble generation amount calculation means for calculating an amount of bubbles generated from the liquid, and the control means for relaxing the bubble countermeasure treatment when the amount of bubble generation calculated by the bubble generation amount calculation means is equal to or less than the predetermined amount. According to this configuration, the bubble countermeasures corresponding to the amount of bubble generation can be performed.

According to the inkjet recording apparatus 1 according to the present embodiment, the bubble generation amount calculation means calculates an amount of bubble generation from the difference between the amount of saturated dissolved gas at the first timing and the amount of saturated dissolved gas at the second timing after the first timing. According to this configuration, it is possible to calculate the amount of bubble generation with high reliability.

Further, according to the inkjet recording apparatus 1 according to the present embodiment, the bubble countermeasure means includes the non-ejection detection means which detects the non-ejection of the liquid from the recording head, and the control means causes the non-ejection detection means to execute the detection when the amount of bubble generation calculated by the bubble generation amount calculation means is larger than the predetermined value, and relaxes the bubble countermeasure treatment when the amount of bubble generation calculated by the calculation means of an amount of bubble generation is less than the reference value. According to this configuration, the bubble countermeasures corresponding to the degree of non-ejection can be performed.

Further, according to the inkjet recording apparatus 1 according to the present embodiment, the bubble countermeasure means includes the purge means which forcibly ejects the liquid from the recording head 21, and the control means decreases the amount of ejection or the ejection frequency of the purge means to relax the bubble countermeasure treatment. According to this configuration, the operation of the purge means can be suppressed when the amount of bubble generation is small.

According to the inkjet recording apparatus 1 according to the present embodiment, the bubble countermeasure means includes the head circulation means which circulates the liquid between the liquid tank and the recording head 21, and the control means decreases the circulation time or the circulation frequency of the head circulation means to relax the bubble countermeasure treatment. According to this configuration, the operation of the head circulation means can be suppressed when the amount of bubble generation is small.

Further, according to the inkjet recording apparatus 1 according to the present embodiment, the bubble countermeasure means includes the degassing means which degasses the liquid in the liquid tank, and the control means decreases the degassing time or the frequency of the degassing means to relax the bubble countermeasure treatment. According to this configuration, when the amount of bubble generation is small, the operation of the degassing means can be suppressed.

The above embodiments may be modified as follows.

The calculation process of an amount of bubble generation (step S01) shown in FIG. 4 may be periodically executed during the image formation by the recording head 21, and when the amount of bubble generation is larger than the predetermined amount (step S02: YES) or the non-ejection is equal to or larger than the reference value (step S03: YES), the image formation may be interrupted, and the strengthening of the bubble countermeasure treatment (step S04) may be performed.

In the above-described embodiment, the present invention is applied to the inkjet recording apparatus 1 provided with the circulation degassing system degassing device 40, but the present invention may be applied to the inkjet recording apparatus 1 provided with the stirring degassing system degassing device for stirring the ink in the ink tank 32 by an impeller.

In the above embodiment, the predetermined amount, which is the threshold value of the amount of bubble generation, is set to 0 (zero), but a positive value may be set as the predetermined amount. Further, it is also possible to set a plurality of predetermined amounts so as to strengthen the bubble countermeasure treatment step by step.

The control means may increase the detection frequency of the non-ejection detection means when the amount of bubble generation calculated by the calculation means is larger than the predetermined amount. According to this configuration, it is possible to decrease the detection omission of non-ejection. Further, the control means may decrease the detection frequency of the non-ejection detection means when the amount of bubble generation calculated by the calculation means is equal to or less than the predetermined amount. According to this configuration, it is possible to suppress the detection of non-ejection when the non-ejection is small.

1. An inkjet recording apparatus comprising:
a recording head which ejects a liquid;
a bubble countermeasure means for executing a bubble countermeasure treatment determined as a countermeasure against bubbles generated in the liquid;
a bubble generation amount calculation means for calculating an amount of bubbles generated from the liquid; and
a control device which relaxes the bubble countermeasure treatment when the amount of bubble generation calculated by the bubble generation amount calculation means equal to or less than a predetermined amount.

2. The inkjet recording apparatus according to claim 1, wherein
the bubble generation amount calculation means calculates the amount of bubble generation from a difference between an amount of saturated dissolved gas of the liquid at a first timing and an amount of saturated dissolved gas of the liquid at a second timing after the first timing.

3. The inkjet recording apparatus according to claim 1, wherein
the bubble countermeasure means includes a non-ejection detection means for detecting a non-ejection of the liquid from the recording head, and
the control device causes the non-ejection detection means to execute detection when the amount of bubble generation calculated by the bubble generation amount calculation means is larger than the predetermined amount, and relaxes the bubble countermeasure treatment when the non-ejection detected by the non-ejection detection means is less than a reference value.

4. The inkjet recording apparatus according to claim 1, wherein
the bubble countermeasure means includes a purge means for forcibly ejecting the liquid from the recording head, and
the control device decreases an amount of ejection or an ejection frequency of the purge means to relax the bubble countermeasure treatment.

5. The inkjet recording apparatus according to claim 1, wherein
the bubble countermeasure means includes a head circulation pump which circulates the liquid between a liquid tank and the recording head, and
the control device decreases a circulation time or a circulation frequency of the head circulation pump to relax the bubble countermeasure treatment.

6. The inkjet recording apparatus according to claim 1, wherein
the bubble countermeasure means includes a degassing device which degasses the liquid in a liquid tank, and
the control device decreases a degassing time or a degassing frequency of the degassing device to relax the bubble countermeasure treatment.

7. The inkjet recording apparatus according to claim 3, wherein
the control device decreases a detection frequency by the non-ejection detection means when the amount of bubble generation calculated by the bubble generation amount calculation means is equal to or less than the predetermined amount.
